(19) United States
(12) Patent Application Publication
(10) Pub. No.: US 2017/0277251 A1
(43) Pub. Date: Sep. 28, 2017

(54) ADAPTIVE POWER SUPPLY CIRCUIT AND SYSTEM

(71) Applicant: Chengdu Monolithic Power Systems Co., Ltd., Chengdu (CN)

(72) Inventor: Junyong Gong, Chengdu (CN)

(21) Appl. No.: 15/455,063

(22) Filed: Mar. 9, 2017

(30) Foreign Application Priority Data
Mar. 24, 2016 (CN) 201610179094.2

(51) Int. Cl. G06F 1/32; G06F 13/362

(52) U.S. Cl. CPC G06F 1/3296; G06F 13/362

(57) ABSTRACT

A power supply system compatible with both USB 2.0 protocol and USB type-C specification. The power supply system monitors the die temperature. It is configured to 1) change the system mode from DCP mode to SDP mode or decrease an output voltage of a power stage; and 2) change resistance values of a first pull up resistor and a second pull up resistor to decrease an output current capability if the die temperature is higher than the temperature threshold.

### CROSS-REFERENCE TO RELATED APPLICATIONS

This application claims priority to and the benefit of Chinese Patent Application No. 201610179094.2, filed Mar. 24, 2016, which is incorporated herein by reference in its entirety.

### FIELD

The present invention relates to electronic circuits, more specifically, the present invention relates to power supply circuit and power supply method.

### BACKGROUND

In USB car charger applications, the environment temperature is high and the PCB size is small. But the plastic housing of the USB car charger limits air flow. As a result, the temperature of the integrated circuit inside the car charger may get very high. For safety concerns, most car makers require the USB charging current to be reduced under high temperature conditions. But present USB 2.0 protocol doesn't support dynamic charge current adjustment. USB type-C specification supports output current adjustment. However, it is not compatible with the USB 2.0 protocol.

### SUMMARY

It is an object of the present invention to provide an improved power supply circuit which is compatible with both USB type-C specification and USB 2.0 protocol, which solves the above problems.

In accomplishing the above and other objects, there has been provided, in accordance with an embodiment of the present invention, a power supply circuit, comprising: a bus port, configured to provide a bus voltage; a power switch, wherein the bus port is coupled to a power stage to receive an output voltage by way of the power switch; a data plus port and a data minus port, coupled to a DCP automatic detector; a first configuration channel port, selectively coupled to a first pull up resistor or to a power supply via a first selective switch; a second configuration channel port, selectively coupled to a second pull up resistor or to the power supply via a second selective switch, wherein the first pull up resistor and the second pull up resistor are controlled by a type-C controller; and a ground port, coupled to a reference ground; wherein if a temperature of the power supply circuit is higher than a temperature threshold: 1) a system mode under USB 2.0 protocol is changed from DCP mode to SDP mode or the output voltage of the power stage is decreased; and 2) the first pull up resistor and the second pull up resistor are controlled to change their resistance values by the type-C controller.

In addition, there has been provided, in accordance with an embodiment of the present invention, a power supply system, including a power supply circuit acting as a downstream facing port and a load coupled to the power supply acting as an downstream facing port, the power supply system configured to decrease an output current capability of the power supply circuit if a temperature of the power supply circuit is higher than a temperature threshold, wherein the power supply circuit comprises: a bus port, configured to provide a bus voltage; a power switch, wherein the bus port is coupled to a power stage to receive an output voltage by way of the power switch; a data plus port and a data minus port, coupled to a DCP automatic detector; a first configuration channel port, selectively coupled to a first pull up resistor or to a power supply via a first selective switch; a second configuration channel port, selectively coupled to a second pull up resistor or to the power supply via a second selective switch, wherein the first pull up resistor and the second pull up resistor are controlled by a type-C controller; and a ground port, coupled to a reference ground; wherein if the temperature of the power supply circuit is higher than the temperature threshold: 1) a system mode under USB 2.0 protocol is changed from DCP mode to SDP mode or the output voltage of the power stage is decreased; and 2) the first pull up resistor and the second pull up resistor are controlled to change their resistance values by the type-C controller.

Furthermore, there has been provided, in accordance with an embodiment of the present invention, a power supply method supporting dual USB protocol, comprising: monitoring a die temperature during a charge process; detecting whether the die temperature is higher than a temperature threshold: if the die temperature is higher than the temperature threshold, 1) changing DCP mode to SDP mode under USB 2.0 protocol or decreasing a bus voltage, and 2) changing resistance values of a first pull up resistor coupled to a first configuration channel port and a second pull up resistor coupled to a second configuration channel port both from a first resistance value to a second resistance value or to a third resistance value under USB type-C specification; if the die temperature is not higher than the temperature, continuing to monitor the die temperature.

### BRIEF DESCRIPTION OF THE DRAWINGS

FIG. 1 schematically shows a power supply circuit 100 with dual USB charge ports in accordance with an embodiment of the present invention.

FIG. 2 schematically shows changing the resistance value of a resistor by removing or adding parallel coupled resistors.

FIG. 3 schematically shows changing the resistance value of a resistor by adding or removing series coupled resistors.

FIG. 4 schematically shows timing waveforms of the die temperature T_{die}, the bus voltage V_{B}, the output current I_{O} in the power supply circuit 100 and the system operation mode at different time periods.

FIG. 5 schematically shows a circuit configuration when a load supporting USB type-C specification is coupled to the power supply circuit 100 in accordance with an embodiment of the present invention.

FIG. 6 schematically shows a block diagram of a power supply circuit 200 in accordance with an embodiment of the present invention.

FIG. 7 schematically shows timing waveforms of the die temperature T_{die}, the bus voltage V_{B}, the output current I_{O} in the power supply circuit 200 and the system operation mode at different time periods in accordance with an embodiment of the present invention.

FIG. 8 schematically shows a flowchart 300 of a power supply method supporting dual USB protocol in accordance with an embodiment of the present invention.

The use of the similar reference label in different drawings indicates the same of like components.

### DETAILED DESCRIPTION

Embodiments of circuits and method for power supply circuit are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

FIG. 1 schematically shows a power supply circuit 100 with dual USB charge ports in accordance with an embodiment of the present invention. In the example of FIG. 1, the power supply circuit 100 comprises: a bus port V_{BUS}, configured to provide a bus voltage; a power switch 102, wherein the bus port V_{BUS} is coupled to a power stage 101 by way of the power switch 102, to receive an output voltage V_{O} provided by the power stage 101; a logical controller 103, configured to provide a switch control signal to control the power switch 102; a data plus port DP and a data minus port DM, coupled to a DCP (dedicated charge port) automatic detector 104; a first configuration channel port CC1, selectively coupled to a first pull up resistor Rₚ₁ or to a power supply V_{conn} via a first selective switch M1; a second configuration channel port CC2, selectively coupled to a second pull up resistor Rₚ₂ or to the power supply V_{conn} via a second selective switch M2, wherein the first pull up resistor Rₚ₁ and the second pull up resistor Rₚ₂ are controlled by a type-C controller 105; and a ground port GND, coupled to a reference ground; wherein the logical controller 103, the DCP automatic detector 104 and the type-C controller 105 are all configured to receive a temperature signal T_{ind} indicative of a temperature status of the power supply circuit 100, if the temperature of the power supply circuit 100 (i.e. die temperature) is higher than a temperature threshold (e.g., 125° C.), the power switch 102 is turned off for a preset time period by the logical controller 103, the system mode under USB 2.0 protocol is changed from DCP mode to SDP (standard downstream port) mode by the DCP automatic detector 104, and the resistance values of the first pull up resistor Rₚ₁ and the second pull up resistor Rₚ₂ are changed by the type-C controller 105.

In one embodiment, the power supply circuit 100 further comprises: a temperature monitor 106, configured to monitor the temperature of the power supply circuit, and compare the monitored result with the temperature threshold, to generate the temperature signal T_{ind}. In other embodiments, the temperature monitor 106 may be an external monitor, which is not integrated in a die (not inside the power supply circuit).

In one embodiment, if the temperature of the power supply circuit 100 is higher than the temperature threshold (e.g., 125° C.), the resistance values of the first pull up resistor Rₚ₁ and the second pull up resistor Rₚ₂ are both changed from a first resistance value (e.g. 10 kΩ) to a second resistance value (e.g. 22 kΩ) under the control of the type-C controller 105, to adjust an output current from a first current value (e.g. 3 A) to a second current value (e.g. 1.5 A). In another embodiment, when the temperature of the power supply circuit 100 is higher than the temperature threshold, the resistance values of the first pull up resistor Rₚ₁ and the second pull up resistor Rₚ₂ are both changed from the first resistance value (e.g. 10 kΩ) to a third resistance value (e.g. 56 kΩ) under the control of the type-C controller 105, to adjust the output current from the first current value (e.g. 3 A) to a third current value (e.g. 500 mA). In yet another embodiment, when the temperature of the power supply circuit 100 is higher than the temperature threshold, the resistance values of the first pull up resistor Rₚ₁ and the second pull up resistor Rₚ₂ are both changed from the second resistance value (e.g. 22 kΩ) to the third resistance value (e.g. 56 kΩ) under the control of the type-C controller 105, to adjust the output current from the current value (e.g. 1.5 A) to the third current value (e.g. 0.5 A).

In real world applications, the power supply circuit 100 acts as a downstream facing port (DFP), and the load coupled to the power supply circuit 100 acts as an upstream facing port (UFP). One of the configuration channel ports (CC1 & CC2) of the DFP is coupled to a configuration channel port of the UFP, whereas the other one is floating. If the first configuration channel port CC1 of DFP is coupled to the configuration channel port of the UFP, and the second configuration channel port CC2 is not coupled to UFP, a second terminal of the first selective switch M1 is selectively coupled to the first pull up resistor Rₚ₁, and a second terminal of the second selective switch M2 is selectively coupled to the power supply V_{conn}. On the contrary, if the second configuration channel port CC2 of DFP is coupled to the configuration channel port of the UFP, and the first configuration channel port CC1 of DFP is not coupled to UFP, the second terminal of the first selective switch M1 is selectively coupled to the power supply V_{conn}, and the second terminal of the second selective switch M2 is selectively coupled to the first pull up resistor Rₚ₂.

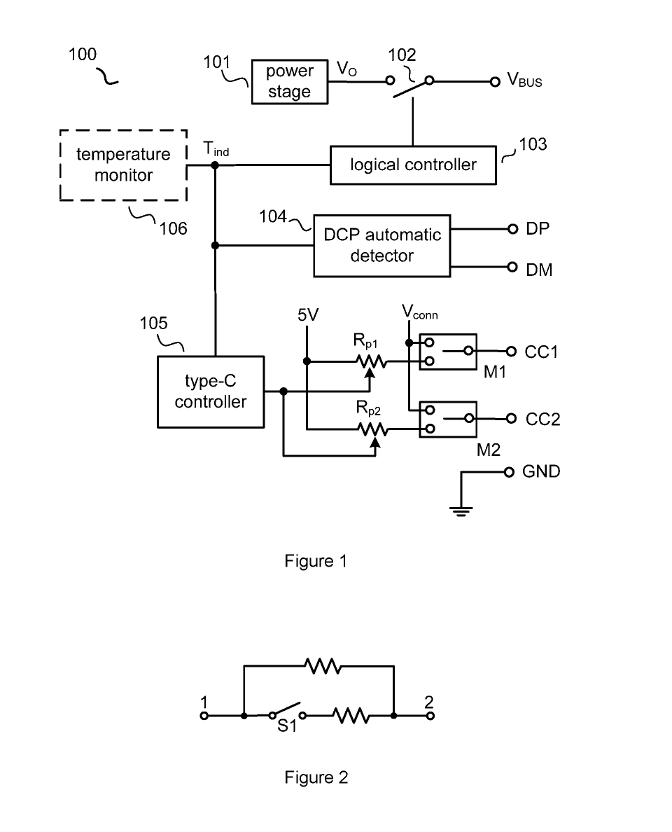

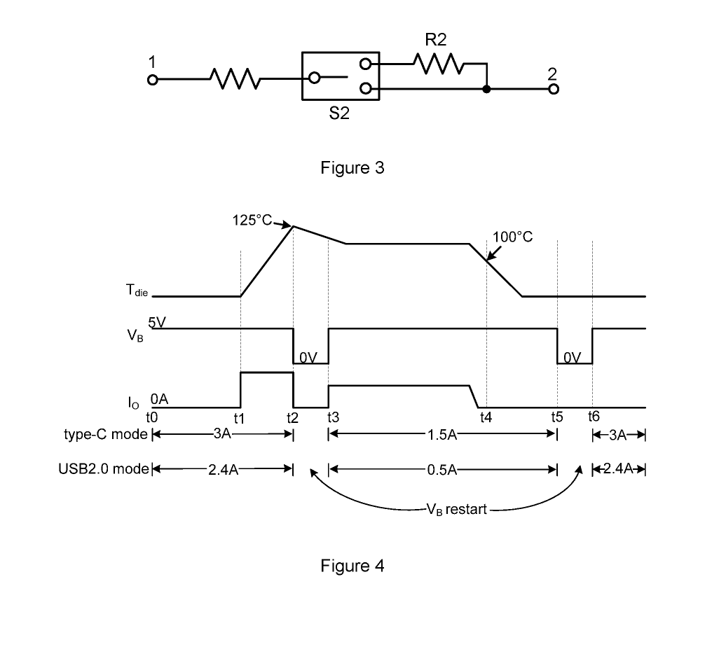

In one embodiment, the resistance values of the first pull up resistor Rₚ₁ and the second pull up resistor Rₚ₂ may be changed by removing and/or adding parallel coupled resistors (e.g., referring to FIG. 2, the equivalent resistance between port 1 and port 2 increases if switch S1 is open; and the equivalent resistance between port 1 and port 2 decreases if switch S1 is closed). In another embodiment, the resistance values of the first pull up resistor Rp1 and the second pull up resistor Rp2 may be changed by adding or removing series coupled resistors (e.g., referring to FIG. 3, the equivalent resistance between port 1 and port 2 increases if selective switch S2 is coupled to an upper port; and the equivalent resistance between port 1 and port 2 decreases if switch S1 is coupled to a lower port). One of ordinary skilled in the art may also use other approaches to change the resistance values of the first pull up resistor Rₚ₁ and the second pull up resistor Rₚ₂.

The power supply circuit 100 complies with both USB 2.0 protocol and USB type-C specification. When a load (e.g. a cell phone) coupled thereto supports USB 2.0 protocol, the power supply circuit 100 contacts with the load and/or charges the load on the basis of USB 2.0 protocol. When the load coupled thereto supports type-C specification, the power supply circuit 100 contacts with the load and/or charges the load on the basis of type-C specification. If the temperature of the power supply circuit exceeds the temperature threshold during the charge process, the system mode is changed to SDP mode by the DCP automatic detector 104, so that the output current is adjusted from 2.4 A to 0.5 A under USB 2.0 protocol; or the resistance values of the pull up resistors (Rₚ₁ & Rₚ₂) are both changed by the controller 105, so that the output current is adjusted from 3 A to 1.5 A or to 500 mA under USB type-C specification.

The operation of the power supply circuit 100 under over temperature condition will be illustrated in combination with FIG. 4.

From t0 to t1 interval: no load is coupled to the power supply circuit 100, the die temperature is room temperature, the voltage V_{B} at the bus port is the output voltage V_{O} (the output voltage V_{O} is 5 V in this example), the output current Io is zero, the output current capability of the power supply circuit 100 under type-C specification is controlled to be 3 A by the type-C controller 105, and the output current capability of the power supply circuit 100 under USB 2.0 protocol is controlled to be 2.4 A by the DCP automatic detector 104.

From t1 to t2 interval: an external load is coupled to and charged by the power supply circuit 100 at time point t1. Accordingly, the die temperature T_{die} starts to rise from room temperature until the die temperature rises to the temperature threshold at time point t2. In the example of FIG. 4, the temperature threshold is 125° C. The bus voltage V_{B} maintains at 5 V, and the output current is 1) 3 A if the load supports type-C specification; or 2) 2.4 A if the load supports USB 2.0 protocol.

From t2 to t3 interval: as discussed above, the die temperature rises to the temperature threshold at time point t2. Accordingly, the power switch 102 is turned off by the logical controller 103, which disconnects the connection between the power stage 101 and the bus port V_{BUS,} so the bus voltage V_{B} turns to zero. The power switch 102 is re-turned on at time point t3. During this internal, the die temperature T_{die} declines due to the shutdown of the bus voltage, and the output current is zero.

From t3 to t4 interval: because the power switch 102 is re-turned on at time point t3, the bus voltage V_{B} goes back to 5V. The die temperature T_{die} continues to decline (e.g. it falls to 100° C. at time point t4). The system mode is controlled to be changed from DCP mode to SDP mode by the DCP automatic detector 104, so that the output current I_{O} is adjusted to 500 mA under USB 2.0 protocol; and the resistance values of the first pull up resistor Rₚ₁ and the second pull up resistor Rₚ₂ are adjusted from the first resistance to the second resistance by the type-C controller 105, so that the output current I_{O} is adjusted to 1.5 A under type-C specification.

From t4 to t5 interval: the charge process is over, and the output current I_{O} falls to zero.

From t5 to-t6 interval: the power switch 102 is re-turned off, and the bus voltage V_{B} enters restarting stage.

After time point t6: the resistance values of the first pull up resistor Rₚ₁ and the second pull up resistor Rₚ₂ are adjusted back to the first resistance value from the second resistance value by the type-C controller 105, so that the output current capability is renewed to 3 A under type-C specification; and the system mode is changed to DCP mode from SDP mode by the DCP automatic detector 104, so that the output current capability is renewed to 2.4 A under USB 2.0 protocol.

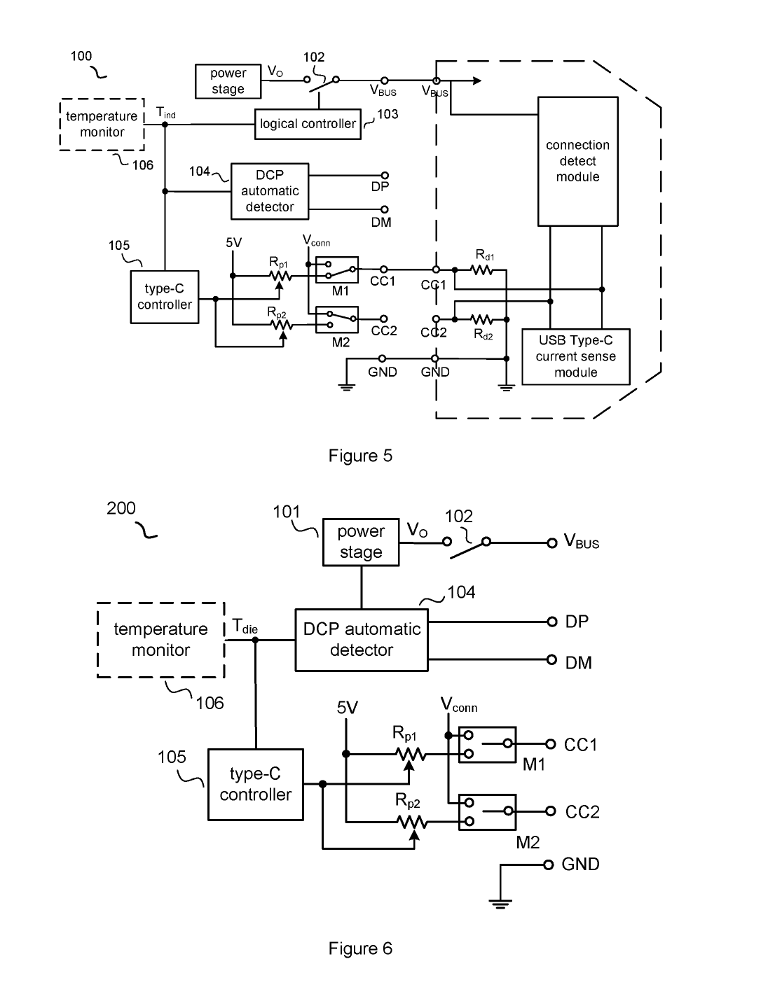

FIG. 5 schematically shows a circuit configuration when a load (shown as the dashed block) supporting USB type-C specification is coupled to the power supply circuit 100 in accordance with an embodiment of the present invention. As shown in FIG. 5, the load comprises: a bus port V_{BUS,} coupled to the bus port of the power supply circuit 100; a first configuration channel port CC1, coupled to the reference ground by way of a first pull down resistor R_{d1}, wherein the first configuration channel port CC1 of the load is also coupled to the first configuration channel port CC1 of the power supply circuit 100; a second configuration channel port CC2, coupled to the reference ground by way of a second pull down resistor R_{d2}; a ground port GND, coupled to the ground port GND of the power supply circuit 100; a connection detect module, coupled to the bus port V_{BUS,} the first configuration channel port CC1 and the second configuration channel port CC2 of the load; and a USB Type-C current sense module, coupled to the first configuration channel port CC1 and the second configuration channel port CC2 of the load. At the example of FIG. 5, the first configuration channel port CC1 of the load is coupled to the first configuration channel port CC1 of the power supply circuit 100 by the user. As a result, at the power supply circuit 100, the second terminal of the first selective switch M1 is coupled to the first pull up resistor Rₚ₁, the second terminal of the second selective switch M2 is coupled to the power supply V_{conn}, the data plus port DP and the data minus port DM are floating. If the die temperature goes higher than the temperature threshold due to the fast charge of the power supply circuit 100, the first pull up resistor Rₚ₁ and the second pull up resistor Rₚ₂ are changed from the first resistance value to the second resistance value or to the third resistance value by the type-C controller 105, so as to change the output current from 3 A to 1.5 A or to 0.5 A, to lower the die temperature. If the die temperature falls back to a normal value (room temperature), the first pull up resistor Rₚ₁ and the second pull up resistor Rₚ₂ are changed from the second resistance value or from the third resistance value back to the first resistance value by the type-C controller 105, so as to renew the output current capacitor to 3 A.

FIG. 6 schematically shows a block diagram of a power supply circuit 200 in accordance with an embodiment of the present invention. In the example of FIG. 6, the power supply circuit 200 comprises: a bus port V_{BUS}, configured to provide a bus voltage; a power switch 102, wherein the bus port V_{BUS} is coupled to a power stage 101 by way of the power switch 102, to receive an output voltage V_{O} provided by the power stage 101; a data plus port DP and a data minus port DM, coupled to a DCP (dedicated charge port) automatic detector 104; a first configuration channel port CC1, selectively coupled to a first pull up resistor Rₚ₁ or to a power supply V_{conn} via a first selective switch M1; a second configuration channel port CC2, selectively coupled to a second pull up resistor Rₚ₂ or to the power supply V_{conn} via a second selective switch M2, wherein the first pull up resistor Rₚ₁ and the second pull up resistor Rₚ₂ are controlled by a type-C controller 105; and a ground port GND, coupled to a reference ground; wherein the DCP automatic detector 104 and the type-C controller 105 are both configured to receive a temperature signal T_{ind} indicative of a temperature status of the power supply circuit 200, if the temperature of the power supply circuit 200 is higher than a temperature threshold (e.g., 125° C.), the DCP automatic detector 104 provides an adjusted signal to the power stage 101, so that the output voltage V_{O} of the power stage decreases until the die temperature falls to an acceptable range (e.g., to a normal temperature reference); and the resistance values of the first pull up resistor Rₚ₁ and the second pull up resistor Rₚ₂ are changed from a first resistance value (e.g. 10 kΩ) to a second resistance value (e.g. 22 kΩ) or to a third resistance value (e.g. 56 kΩ) by the type-C controller 105, so that the output current is adjusted from 3 A to 1.5 A or to 0.5 A.

In one embodiment, the power supply circuit 200 further comprises: a temperature monitor 106, configured to monitor the temperature of the power supply circuit 200, and compare the monitored result with the temperature threshold, to generate the temperature signal T_{ind}. In other embodiments, the temperature monitor 106 is an external monitor, which is not integrated in a die.

In one embodiment, when the output voltage V_{O} of the power stage 101 decreases under the control of the DCP automatic detector 104, the output current capability under USB 2.0 decreases correspondingly.

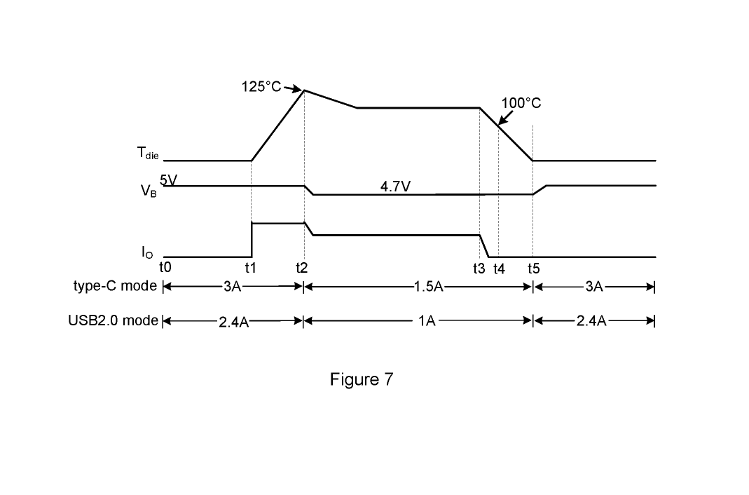

The operation of the power supply circuit 200 under over temperature condition will be illustrated in combination with FIG. 7 in accordance with an embodiment of the present invention. In the shown example, the output voltage V_{O} of the power stage 101 decreases from 5 V to 4.7 V under the control of the DCP automatic detector 104 when the die temperature goes higher than the temperature threshold. Accordingly, the output current capability is adjusted from 2.4 A to 1 A.

From t0 to t1 interval: no load is coupled to the power supply circuit 200, the die temperature is room temperature, the voltage V_{B} at the bus port is 5 V, the output current lo is zero, the output current capability of the power supply circuit 200 under type-C specification is controlled to be 3 A by the type-C controller 105, and the output current capability of the power supply circuit 200 under USB 2.0 protocol is controlled to be 2.4 A by the DCP automatic detector 104.

From t1 to t2 interval: an external load is coupled to and charged by the power supply circuit 200 at time point t1. Accordingly, the die temperature T_{die} starts to rise from room temperature until the die temperature rises to the temperature threshold at time point t2. In the example of FIG. 7, the temperature threshold is 125° C. The bus voltage V_{B} maintains at 5 V and the output current is 1) 3 A if the load supports type-C specification; or 2) 2.4 A if the load supports USB 2.0 protocol.

From t2 to t3 interval: as discussed above, the die temperature rises to the temperature threshold at time point t2. Accordingly, the DCP automatic detector 104 provides an adjusted signal to the power stage 101, so that the output voltage V_{O} of the power stage 101 decreases to 4.7 V, and the output current I_{O} decreases to 1 A under USB 2.0 protocol; the resistance values of the first pull up resistor Rₚ₁ and the second pull up resistor Rₚ₁ are changed from the first resistance value to the second resistance value under the control of the type-C controller 105, so that the output current under USB type-C specification decreased to 1.5 A. As a result, the die temperature falls down.

From t3 to t5 interval: the charge process ends at time point t3. Then the output current I_{O} falls to zero and the die temperature continues to decline (e.g., it falls to 100° C. at time point t4) until time point t5 at when the die temperature falls to room temperature.

After time point t5: as discussed above, the die temperature falls to room temperature at time point t5. Then the output voltage V_{O} of the power stage 101 is renewed to 5 V under the control of the DCP automatic detector 104, the output current capability under USB 2.0 protocol is renewed to 2.4 A; and the resistance values of the first pull up resistor Rₚ₁ and the second pull up resistor Rₚ₂ are adjusted back to the first resistance value from the second resistance value by the type-C controller 105, so that the output current capability under type-C specification is renewed to 3 A.

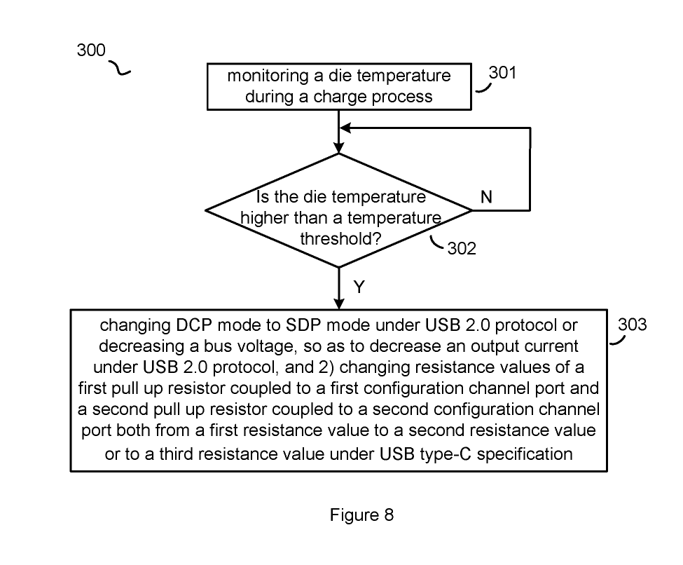

FIG. 8 schematically shows a flowchart 300 of a power supply method supporting dual USB protocol in accordance with an embodiment of the present invention. The method comprises:

Step 301, monitoring a die temperature during a charge process.

Step 302, detecting whether the die temperature is higher than a temperature threshold: if the die temperature is higher than the temperature threshold, go to step 303; and if the die temperature is not higher than the temperature, go back to step 301.

Step 303, 1) changing DCP (dedicated charge port) mode to SDP (standard downstream port) mode under USB 2.0 protocol or decreasing a bus voltage, so as to decrease an output current under USB 2.0 protocol, and 2) changing resistance values of a first pull up resistor coupled to a first configuration channel port and a second pull up resistor coupled to a second configuration channel port both from a first resistance value to a second resistance value or to a third resistance value under USB type-C specification, so as to decrease the output current under USB type-C specification.

In one embodiment, the method further comprises: when the charge process is over, and the die temperature falls to room temperature or the output current is lower than a lower current threshold, 1) changing SDP mode back to DCP mode under USB 2.0 protocol or renewing the bus voltage, and 2) changing the resistance values of the first pull up resistor and the second pull up resistor from the second resistance value or from the third resistance value back to the first resistance value under USB type-C specification.

In one embodiment, the output current deceases from 2.4 A to 500 mA when the mode is changed from DCP mode to SDP mode under USB 2.0 protocol; and the output current decreases from 2.4 A to 1 A when the bus voltage decreases under USB 2.0 protocol.

In one embodiment, if the resistance values of the first pull up resistor and the second pull up resistor are both changed from the first resistance value to the second resistance value under USB type-C specification, the output current decreases from 3 A to 1.5 A; and if the resistance values of the first pull up resistor and the second pull up resistor are both changed to the third resistance value under USB type-C specification, the output current decreases to 0.5 A.

Several embodiments of the foregoing power supply circuit and power supply method support both USB 2.0 protocol and USB type-C specification. If the temperature of the power supply circuit goes higher than a temperature threshold, the output current is adjusted, so as to lower the temperature of the power supply circuit, and insure the security of the charge.

It is to be understood in these letters patent that the meaning of “A” is coupled to “B” is that either A and B are connected to each other as described below, or that, although A and B may not be connected to each other as described above, there is nevertheless a load or circuit that is connected to both A and B. This load or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

What is claimed is:

1. A power supply circuit, comprising:
a bus port, configured to provide a bus voltage;
a power switch, wherein the bus port is coupled to a power stage to receive an output voltage by way of the power switch;
a data plus port and a data minus port, coupled to a DCP automatic detector;
a first configuration channel port, selectively coupled to a first pull up resistor or to a power supply via a first selective switch;
a second configuration channel port, selectively coupled to a second pull up resistor or to the power supply via a second selective switch, wherein the first pull up resistor and the second pull up resistor are controlled by a type-C controller; and
a ground port, coupled to a reference ground; wherein
if a temperature of the power supply circuit is higher than a temperature threshold: 1) a system mode under USB 2.0 protocol is changed from DCP mode to SDP mode or the output voltage of the power stage is decreased; and 2) the first pull up resistor and the second pull up resistor are controlled to change their resistance values by the type-C controller.

2. The power supply circuit of claim 1, further comprising:
a logical controller, configured to provide a switch control signal to control the power switch; wherein the logical controller is configured to turn off the power switch for a preset time period if the temperature of the power supply circuit is higher than the temperature threshold.

3. The power supply circuit of claim 1, further comprising:
a temperature monitor, configured to monitor the temperature of the power supply circuit, and compare the monitored result with the temperature threshold, to generate a temperature signal indicative of a temperature status of the power supply circuit.

4. The power supply circuit of claim 1, wherein if the temperature of the power supply circuit is higher than the temperature threshold, the resistance values of the first pull up resistor and the second pull up resistor are both changed from a first resistance value to a second resistance value under the control of the type-C controller.

5. The power supply circuit of claim 1, wherein the power supply circuit acts as a downstream facing port.

6. The power supply circuit of claim 1, wherein the resistance values of the first pull up resistor and the second pull up resistor are changed by removing and/or adding parallel coupled resistors.

7. The power supply circuit of claim 1, wherein the resistance values of the first pull up resistor and the second pull up resistor are changed by adding or removing series coupled resistors.

8. The power supply circuit of claim 1, wherein in real applications, one of the first and second configuration channel ports is coupled to a configuration channel port of an upstream facing port, and the other one is floating, and wherein the one coupled to the configuration channel port of the upstream facing port is selectively coupled to the corresponding pull up resistor, while the other one is selectively coupled to the power supply.

9. A power supply system, including a power supply circuit acting as a downstream facing port and a load coupled to the power supply acting as an downstream facing port, the power supply system configured to decrease an output current capability of the power supply circuit if a temperature of the power supply circuit is higher than a temperature threshold, wherein the power supply circuit comprises:
a bus port, configured to provide a bus voltage;
a power switch, wherein the bus port is coupled to a power stage to receive an output voltage by way of the power switch;
a data plus port and a data minus port, coupled to a DCP automatic detector;
a first configuration channel port, selectively coupled to a first pull up resistor or to a power supply via a first selective switch;
a second configuration channel port, selectively coupled to a second pull up resistor or to the power supply via a second selective switch, wherein the first pull up resistor and the second pull up resistor are controlled by a type-C controller; and
a ground port, coupled to a reference ground; wherein
if the temperature of the power supply circuit is higher than the temperature threshold: 1) a system mode under USB 2.0 protocol is changed from DCP mode to SDP mode or the output voltage of the power stage is decreased; and 2) the first pull up resistor and the second pull up resistor are controlled to change their resistance values by the type-C controller.

10. The power supply circuit of claim 9, further comprising:
a logical controller, configured to provide a switch control signal to control the power switch; wherein the logical controller is configured to turn off the power switch for a preset time period if the temperature of the power supply circuit is higher than the temperature threshold.

11. The power supply circuit of claim 9, further comprising:
a temperature monitor, configured to monitor the temperature of the power supply circuit, and compare the monitored result with the temperature threshold, to generate a temperature signal indicative of temperature status of the power supply circuit.

12. The power supply circuit of claim 9, wherein if the temperature of the power supply circuit is higher than the temperature threshold, the resistance values of the first pull up resistor and the second pull up resistor are both changed from a first resistance value to a second resistance value under the control of the type-C controller.

13. The power supply circuit of claim 9, wherein the resistance values of the first pull up resistor and the second pull up resistor are changed by removing and/or adding parallel coupled resistors.

14. The power supply circuit of claim 9, wherein the resistance values of the first pull up resistor and the second pull up resistor are changed by adding or removing series coupled resistors.

15. The power supply circuit of claim 9, wherein one of the first and second configuration channel ports is coupled to a configuration channel port of the load, and the other one is floating, and wherein the one coupled to the configuration channel port of the load is selectively coupled to the corresponding pull up resistor, while the other one is selectively coupled to the power supply.

16. A power supply method supporting dual USB protocol, comprising:
monitoring a die temperature during a charge process;
detecting whether the die temperature is higher than a temperature threshold:
if the die temperature is higher than the temperature threshold, 1) changing DCP mode to SDP mode under USB 2.0 protocol or decreasing a bus voltage, and 2) changing resistance values of a first pull up resistor coupled to a first configuration channel port and a second pull up resistor coupled to a second configuration channel port both from a first resistance value to a second resistance value or to a third resistance value under USB type-C specification;
if the die temperature is not higher than the temperature, continuing to monitor the die temperature.

17. The power supply method of claim 16, further comprising:
when the charge process is over, and the die temperature falls to room temperature or the output current is lower than a lower current threshold, 1) changing SDP mode back to SDP mode under USB 2.0 protocol or renewing the bus voltage, and 2) changing the resistance values of the first pull up resistor and the second pull up resistor from the second resistance value or from the third resistance value back to the first resistance value under USB type-C specification.

18. The power supply method of claim 16, wherein
when system mode is changed from DCP mode to SDP mode, an output current capability is changed from 2.4 A to 500 mA; and
when the bus voltage is decreased, the output current capability is changed from 2.4 A to 1 A.
